(19) United States
(12) Patent Application Publication
(10) Pub. No.: US 2011/0092620 A1
(43) Pub. Date: Apr. 21, 2011

(54) Carbodiimides and 2-(1,1-dimethylethyl)-6-[[3-(1,1-dimethylethyl)-2-hydroxy-5-methylphenyl]methyl-4-methylphenyl] acrylate as colour stabilizers in hot-melt adhesives

(75) Inventors: Christian Scheffner, Sandhausen (DE); Bernd Kray, Speyer (DE); Wilhelm Laufer, Ellerstadt (DE); Serdar Uestuenbas, Mannheim (DE)

(73) Assignee: RHEIN CHEMIE RHEINAU GMBH, MANNHEIM (DE)

(21) Appl. No.: 12/860,997

(22) Filed: Aug. 23, 2010

(30) Foreign Application Priority Data
Sep. 2, 2009 (EP) 09169293.9

(51) Int. Cl. C08K 5/29; C08K 5/3475; C08K 5/52; C08K 5/353

(52) U.S. Cl. 524/91; 524/195; 524/140; 524/94

(57) ABSTRACT

The present invention relates to hot-melt adhesive compositions comprising in addition to 2-(1,1-dimethylethyl)-6-[[3-(1,1-dimethylethyl)-2-hydroxy-5-methylphenyl]methyl-4-methylphenyl]acrylate as an antioxidant at least one carbodiimide compound.

The present invention relates to hot-melt adhesive compositions comprising in addition to 2-(1,1-dimethylethyl)-6-[[3-(1,1-dimethylethyl)-2-hydroxy-5-methylphenyl]methyl-4-methylphenyl]acrylate as an antioxidant at least one carbodiimide compound.

The present invention further relates to the use of 2-(1,1-dimethylethyl)-6-[[3-(1,1-dimethylethyl)-2-hydroxy-5-methylphenyl]methyl-4-methylphenyl]acrylate and/or carbodiimides for colour stabilization of hot-melt adhesives in the melt.

Colour stabilization for the purposes of the present invention comprises protecting hot-melt adhesives from a change in colour. More particularly, colour stabilization for the purposes of the present invention is to be understood as meaning that a hot-melt adhesive in the melt will not undergo a change in colour. Even more particularly, colour stabilization for the purposes of the present invention is to be understood as meaning that the hot-melt adhesive is subjected to a temperature of 130° C. in the absence of light for a period of at least 48 hours and substantially no colour change takes place during this period.

Hot-melt adhesives are solvent-free products which have a certain solidity at room temperature and which are applied in the hot state to the surface of an article for example and, on cooling, engender a bond between the surface of the article and a further surface. Hot-melt adhesives, also known as hotmelts, are based on various chemical systems.

In use, the hot-melt adhesive is made to melt and is fed in a softened form to a coating head for example. From there, the molten adhesive is pressed through a mould to form the layer of adhesive.

Hot-melt adhesive systems are widely known from the prior art.

EP 1 533 331 A describes polyamides based on C₄-C₁₈ dicarboxylic acids and diamines as a moulding material for producing moulded articles in the low-pressure injection moulding process. By way of use, other moulded articles, such as cables, connectors and grommets, are said to be insert-mouldable in such liquid hot-melt adhesive articles to thereby produce a firm mechanical connection.

EP 0 586 450 A describes hot-melt adhesives composed, inter alia, of polyamide which have a certain melting range. Such molten hot-melt adhesives can then be used to encapsulate cables or connectors. These result in an adhered and waterproof seal surrounding the connector.

Nonreactive hot-melt adhesives are also known. EP 1 124 911 A describes hot-melt adhesives based on poly-α-olefins. These are more particularly described for sprayed application of hot-melt adhesive. EP 0 388 716 A describes hot-melt adhesives based on ethylene-acrylic acid-acrylic ester copolymers. These copolymers serve to adhere solid substrates. Furthermore, EP 0 890 584 A describes hot-melt adhesives consisting of polyolefins produced by metallocene-catalyzed synthesis. Such hot-melt adhesives have a particularly narrow molecular weight distribution and a narrow melting range.

DE 19 924 138 A describes hot-melt adhesive compositions containing nanoscale ferromagnetic particles. Such adhesive bonds are said to be heatable via electromagnetic radiation, and are then easily dissoluble.

These known hot-melt adhesives have the disadvantage of not having colour stability for prolonged periods when stored in the melt.

Storage in the melt for prolonged periods is frequently necessary when using hot-melt adhesives, for example when transporting hot-melt adhesives in temperature-controlled vessels or during downtimes of machines in which hot-melt adhesives are produced, processed or alternatively used.

Typically, hot-melt adhesive systems are provided in drums or containers of up to 200 kg on production lines, and hot-melt adhesive is melted therein. Depending on the process and equipment, the reactive hot-melt adhesives may be subjected to appreciable thermal stresses which may also be sustained.

A customary result of such thermal stresses is a distinct change in the colour of the hot-melt adhesive.

To prevent any colour change on the part of the hot-melt adhesives, hot-melt adhesives are frequently additized with appropriate additives, such as antioxidants based on phenols. EP 0 749 463 A, for instance, describes the use of Irganox® 1010 phenol-based antioxidant as a colour stabilizer in hot-melt adhesives.

However, these colour stabilizers have the disadvantage that their colour-stabilizing effect is not always satisfactory.

It is an object of the present invention to provide an improved method of stabilizing the colour of hot-melt adhesives. The method shall more particularly be suitable for hot-melt adhesive in the melt, preventing any change in colour when the hot-melt adhesive is in the molten state for a prolonged period.

We have found that this object is achieved by the conjoint use of carbodiimides with 2-(1,1-dimethylethyl)-6-[[3-(1,1-dimethylethyl)-2-hydroxy-5-methylphenyl]methyl-4-methylphenyl]acrylate as specific antioxidant for colour stabilization of hot-melt adhesives in the melt.

The present invention accordingly first provides a hot-melt adhesive composition comprising at least 2-(1,1-dimethylethyl)-6-[[3-(1,1-dimethylethyl)-2-hydroxy-5-methylphenyl]methyl-4-methylphenyl]acrylate as antioxidant and at least one carbodiimide compound.

The present invention further provides for the use of 2-(1,1-dimethylethyl)-6-[[3-(1,1-dimethylethyl)-2-hydroxy-5-methylphenyl]methyl-4-methylphenyl]acrylate and/or at least one carbodiimide compound for colour stabilization of hot-melt adhesives in the melt.

The present invention yet further provides for the use of at least one carbodiimide compound in combination with at least 2-(1,1-dimethylethyl)-6-[[3-(1,1-dimethylethyl)-2-hydroxy-5-methylphenyl]methyl-4-methylphenyl]acrylate and optionally further antioxidants for colour stabilization of hot-melt adhesives in the melt.

The present invention lastly provides a process for producing hot-melt adhesives according to the present invention, comprising at least 2-(1,1-dimethylethyl)-6-[[3-(1,1-dimethylethyl)-2-hydroxy-5-methylphenyl]methyl-4-methylphenyl]acrylate as antioxidant and at least one carbodiimide compound.

It is known from the prior art to use carbodiimides as hydrolysis control agent for hot-melt adhesives.

WO 02/090454 A, for instance, discloses the use of carbodiimides as hydrolysis control agents in hot-melt adhesives. The use of carbodiimides as colour-stabilizing agents in hot-melt adhesives in the melt is not known from this prior art, however. In addition, it is known from experience that the amounts of carbodiimides used for effective hydrolysis control are large, whereas the colour stabilization of hot-melt adhesives by means of carbodiimides in the melt of hot-melt adhesives can be achieved with relatively small amounts of the additive.

The present invention accordingly provides a person skilled in the art with the technical teaching to use carbodiimides not as hydrolysis control agents but for stabilizing the colour of hot-melt adhesives in the melt in combination with specific antioxidants.

### (1) Antioxidants

The antioxidant used for the use provided by the present invention is 2-(1,1-dimethylethyl)-6-[[3-(1,1-dimethylethyl)-2-hydroxy-5-methylphenyl]methyl-4-methylphenyl]acrylate. It is likewise possible to use further antioxidants selected from the group consisting of antioxidants based on sterically hindered phenols, based on tocopherol, based on bisbenzotriazoles, based on phosphites, based on thiophenylbisbenzoxazole derivatives and based on benzophenone.

For the purposes of the present invention, the expression “based on” in connection with an antioxidant is to be understood as meaning that the antioxidant comprises corresponding units; that is, for the purposes of the present invention, “based on sterically hindered phenols”, for example, is to be understood as meaning that the antioxidant comprises at least one structural unit derived from a sterically hindered phenol.

When an antioxidant based on a sterically hindered phenol is used, possibilities include, for example, ethylenebis(oxyethylene)bis(3-(5-tert-butyl-4-hydroxy-m-tolyl) propionate), 1,3,5-trimethyl-2,4,6-tris(3,5-di-tert-butyl-4-hydroxybenzyl)benzene, pentaerythritol tetrakis-3-(3,5-di-tert-butyl-4-hydroxyphenyl)propionate, n-octadecyl 3,5-di-tert-butyl-4-hydroxyphenyl)propionate, 4,4′-methylenebis(2,6-di-tert-butylphenol), 4,4′-thiobis(6-tert-butyl-o-cresol), 2,6-di-tert-butylphenol, 6-(4-hydroxyphenoxy)-2,4-bis(n-octylthio)-1,3,5-triazine, di-n-octadecyl 3,5-di-tert-butyl-4-hydroxybenzylphosphonate, 2-(n-octylthio)ethyl 3,5-di-tert-butyl-4-hydroxybenzoate, 2-(1,1-dimethylethyl)-6-[[3-(1,1-dimethylethyl)-2-hydroxy-5-methylphenyl]methyl-4-methylphenyl]acrylate and sorbitol hexa[3-(3,5-di-tert-butyl-4-hydroxyphenyl)propionate]. Corresponding antioxidants are commercially available under the brand name of IRGANOX®. Particular representatives of this product range are
IRGANOX® 245, which comprises ethylenebis(oxyethylene)bis(3-(5-tert-butyl-4-hydroxy-m-tolyl) propionate),
IRGANOX® 3052, which comprises 2-(1,1-dimethylethyl)-6-[[3-(1,1-dimethylethyl)-2-hydroxy-5-methylphenyl]methyl-4-methylphenyl]acrylate,
Irganox® 1010, which comprises (pentaerythritol tetrakis(3-3,5-di-tert-butyl-4-hydroxyphenyl)propionate).

When an antioxidant based on tocopherol is used, possibilities include, for example, α-tocopherol, β-tocopherol, δ-tocopherol and γ-tocopherol.

When an antioxidant based on bisbenzotriazole is used, possibilities include, for example, hydroxyphenylbenzotriazole and its derivatives and also hydroxybenzotriazoles and their derivatives, such as 2-(3′,5′-bis(1,1-dimethylbenzyl)-2′-hydroxyphenyl)benzotriazole (Tinuvin® 234, Ciba Spezialitätenchemie, Basle), 2-(2′-hydroxy-5′-(tert-octyl)phenyl)benzotriazole (Tinuvin® R 329, Ciba Spezialitätenchemie, Basle), 2-(2′-hydroxy-3′-(2-butyl)-5′-(tert-butyl)phenyl)benzotriazole (Tinuvin® 350, Ciba Spezialitätenchemie, Basle), bis(3-(2H-benzotriazolyl)-2-hydroxy-5-tert-octyl)methane (Tinuvin® 360, Ciba Spezialitätenchemie, Basle), 2-(4-hexoxy-2-hydroxyphenyl)-4,6-diphenyl-1,3,5-triazine (Tinuvin® 1577, Ciba Spezialitätenchemie, Basle) and 2-(2H-benzotriazol-2-yl)-6-dodecyl-4-methylphenol (Tinuvin® 571, Ciba Spezialitätenchemie, Basle). Corresponding antioxidants, as mentioned, are commercially available under the brand name of TINUVIN® for example. A particular representative of this product range is TINUVIN® 213, which comprises the reaction product of methyl 3-(3-(2H-benzotriazol-2-yl)-5-t-butyl-4-hydroxyphenylpropionate with polyethylene glycol, for example PEG 300.

When an antioxidant based on phosphites is used, possibilities include, for example, tris(2,4-di-tert-butylphenyl) phosphite. This product is for example available from Ciba Speciality Chemicals Corp. as IRGAFOS® 168.

When an antioxidant based on thiophenylbisbenzoxazole derivatives is used, possibilities include, for example, tris(2,4-di-tert-butylphenyl) phosphite. A particular representative of this product range is Uvitex® OB.

When an antioxidant based on benzophenone is used, possibilities include, for example, Chimasorb® 22 (2,4-dihydroxybenzophenone, Ciba Spezialitätenchemie, Basle); Chimasorb® 81, Ciba Spezialitätenchemie, Basle; or Chimasorb® 90, Ciba Spezialitätenchemie, Basle. A particular representative of this product range is Chimasorb® 90.

In general, the antioxidants are used in amounts of, in each case, between 0.001% by weight and 10% by weight, preferably 0.01% by weight and 5% by weight, more preferably 0.01% by weight and 1% by weight, even more preferably between 0.1% and 1% by weight and yet even more preferably between 0.2% and 0.6% by weight, all based on the hot-melt adhesive/the hot-melt adhesive composition.

### (2) Hot-Melt Adhesive

The present invention can utilize any desired hot-melt adhesive, as described for example in DE 10 2005 030 431, the disclosure of which in this regard is hereby incorporated herein by reference. The hot-melt adhesive may comprise for example reactive or nonreactive hot-melt adhesives. Such hot-melt adhesives are based on polymeric systems selected for example from the group consisting of polyamides, copolyamides, polyolefins, ethylene-vinyl acetate copolymers, polyesters, polyurethanes, polyacrylates and vinylpyrrolidone-vinyl acetate copolymers.

The present invention utilizes more particularly a hot-melt adhesive based on polymeric systems selected from the group consisting of polyurethanes, polyamides, copolyamides, polyolefins, ethylene-vinyl acetate copolymers, polyesters, polyacrylates and vinylpyrrolidone-vinyl acetate copolymers.

It is particularly preferable for the combined use of at least one carbodiimide and at least one antioxidant to take place in reactive hot-melt adhesives based on polyurethane (PU hotmelt).

Some hot-melt adhesive systems which are particularly preferable for the purposes of the present invention will now be more particularly described. However, the present invention is not limited to these hot-melt adhesive systems.

Use for ethylene-vinyl acetate copolymers include all commercially available EVA rubbers. The EVA rubbers with a vinyl acetate fraction of up to 40% are preferable for use as hot-melt adhesives. They are obtainable for example as Levamelt® from Lanxess Deutschland GmbH or else from Henkel under Alcudia EVA or Escorene.

Polyacrylates for the purposes of the invention are obtainable for example by polymerization or copolymerization of ethylenically unsaturated carboxylic esters, such as acrylic, methacrylic, crotonic or maleic esters, as described in DE 10 2005 030 431 for example.

The vinylpyrrolidone-vinyl acetate copolymers likewise comprise commercial products available, for example, from BASF AG under the trade name of Kollidon®.

### Polyester Hot-Melt Adhesives

Hot-melt adhesives based on polyesters are described for example in EP 0 028 687 A, the disclosure of which in this regard is hereby incorporated herein by reference.

Polyester hot-melt adhesives comprise reaction products of aliphatic, cycloaliphatic or aromatic dicarboxylic acids capable of being reacted with aliphatic cyclic or aromatic polyols. By selecting the carboxylic acids and the polyols it is possible to obtain wholly or partly crystalline polyesters. It is typical to react dicarboxylic acids and diols with each other, but it is also possible to use a proportion of tricarboxylic acids or triols.

### Polyurethane Hot-Melt Adhesives

EP 0 434 467 A or DE 41 28 274 A, the disclosure of which in this regard is hereby incorporated herein by reference, describes thermoplastic polyurethanes useful as hot-melt adhesives. Concerned here are reaction products of polyols with polyisocyanates, which may have an enhanced modulus. Useful polyols include the well known polyols based on polyethers, polyesters, polyacrylates, polybutadienes, polyols based on vegetable raw materials, such as oleochemical polyols. To achieve good reactivity, it is customary to include at least a proportion of aromatic isocyanates. By selecting the polyols and/or isocyanates it is possible to influence the properties of the prepolymer, for example the melting point, the elasticity or the adherence. However, it is also possible to use reactive thermoplastic polyurethanes which may then, after application, be capable of forming durable crosslinking.

The present invention is particularly useful for colour stabilization of polyurethane hot-melt adhesives based on diphenylmethane diisocyanate (MDI).

Suitable polyurethane hot-melt adhesives are described for example in WO 95/33783 A1 and WO 02/090454 A1, the disclosure of which in this regard is hereby incorporated herein by reference.

### Polyolefin Hot-Melt Adhesives

For the purposes of the present invention it is further possible to use hot-melt adhesives based on chain-growth addition polymers, for example polyolefins. Amorphous, partly crystalline or wholly crystalline polyolefins are concerned here. Polypropylene or polyethylene copolymers are appropriate examples. The properties of such polymers can be influenced via their molecular weight and via the copolymerized comonomers. Such hot-melt adhesives are described for example in WO 2004/039907 A, the disclosure of which in this regard is hereby incorporated herein by reference. Polymers produced by metallocene catalysis are concerned here, although the present invention is not limited to polyolefins produced by metallocene catalysis. It is thus further possible to use polyolefins produced by heterogeneous catalysis over titanium and aluminium compounds as hot-melt adhesives in the present invention.

### Polyamide/Copolyamide Hot-Melt Adhesives

Useful hot-melt adhesives further include polyamides and/or copolyamides for example. The copolyamides comprise commercially available products, for example Vestamelt® from Evonik Degussa. Suitable polyamides are described for example in EP 0 749 463 A, the disclosure of which in this regard is hereby incorporated herein by reference.

Polyamide hot-melt adhesives based on dicarboxylic acids and polyether diamines are concerned here. Particularly suitable hot-melt adhesive compositions are also described in EP 0 204 315 A. Polyester amides prepared on the basis of polymeric fatty acids and polyamines are concerned here.

Polyamides useful for the purposes of the present invention include for example polyamides based on polyamides free of dimeric fatty acid. These are obtainable from
40 to 50 mol %, preferably 50 mol %, of one or more C₄-C₁₈ dicarboxylic acids;
5 to 45 mol %, preferably 15 to 40 mol %, of at least one aliphatic diamine;
5 to 40 mol %, preferably 20 to 30 mol %, of one or more cycloaliphatic diamines;
0 to 40 mol %, preferably 5 to 25 mol % of polyether diamines,
   where the diamines used sum to 50 mol %, and so the dicarboxylic acid component and the diamine component are present in approximately equivalent molar proportions.

Actually, the dicarboxylic acids are preferably used in up to 10% stoichiometric excess over the diamines, and so carboxyl-terminated polyamides are formed. The molecular weight of the polyamides to be used according to the present invention is (reckoned from the acid number) about 10 000 to 50 000, preferably 15 000 to 30 000. These polyamides suitable for the purposes of the present invention have a viscosity between 5000 and 60 000 mPas, preferably between 15 000 and 50 000 mPas (measured at 200° C., Brookfield Thermosel RVT, EN ISO 2555).

Examples of dicarboxylic acids for preparing the polyamides of the present invention are, in particular, adipic acid, azelaic acid, succinic acid, dodecanedioic acid, glutaric acid, suberic acid, maleic acid, pimelic acid, sebacic acid, undecanedioic acid or mixtures thereof.

The diamine component consists essentially of one or more aliphatic diamines, preferably having an even number of carbon atoms, in which case the amino groups are at the ends of the carbon chains. The aliphatic diamines may contain 2 up to 20 carbon atoms, in which case the aliphatic chain may be linear or lightly branched. Specific examples are ethylenediamine, diethylenetriamine, dipropylenetriamine, 1,4-diaminobutane, 1,3-pentanediamine, methylpentanediamine, hexamethylenediamine, trimethylhexamethylenediamine, 2-(2-aminomethoxy)ethanol, 2-methylpentamethylenediamine, C₁₁-neopentanediamine, diaminodipropylmethylamine, 1,12-diaminododecane. C₄-C₁₂ Diamines having an even number of carbon atoms are particularly preferred aliphatic diamines.

The amino component may further include cyclic diamines or heterocyclic diamines, for example 1,4-cyclohexanediamine, 4,4′-diaminodicyclohexylmethane, piperazine, cyclohexanebis(methylamine), isophoronediamine, dimethylpiperazine, dipiperidyipropane, norbornanediamine or m-xylylenediamine. When the polyaminoamide is to have a comparatively high level of flexibility, polyoxyalkylenediamines can be used in addition, examples being polyoxyethylenediamines, polyoxypropylenediamines or bis(diaminopropyl)polytetrahydrofuran. Of these, the polyoxyalkylenediamines are particularly preferred.

It is further possible to use amino carboxylic acids or cyclic derivatives thereof. 6-Aminohexanoic acid, 11-aminoundecanoic acid, laurolactam and ε-caprolactam may be mentioned here by way of example.

A further embodiment of hot-melt adhesives useful for the purposes of the present invention contains a polyamide based on dimerized fatty acid as an essential component. Dimerized fatty acids are obtained by coupling unsaturated long-chain monobasic fatty acids, for example linolenic acid and oleic acid. The acids are well known and are commercially available.

The polyamides according to the present invention are composed for example from
35 to 49.5 mol % of dimerized fatty acid and also
0.5 to 15 mol % of monomeric fatty acid having 12 to 22 carbon atoms and
2 to 35 mol % of polyether diamines of the general formula

H₂N—R¹—O—(R²O)ₓ—R³—NH₂ (I)
where
x is a number between 8 and 80, more particularly between 8 and 40,
R¹ and R³ are identical or different aliphatic and/or cycloaliphatic hydrocarbyl radicals having preferably 2 to 8 carbon atoms,
R² is an optionally branched aliphatic hydrocarbyl radical having 1 to 6 carbon atoms, and
15 to 48 mol % of aliphatic diamines having 2 to 40 carbon atoms, wherein the dimerized fatty acids may be up to 65% replaced by aliphatic dicarboxylic acids having 4 to 12 carbon atoms.

Another suitable composition is obtainable from
20 to 49.5 mol % of dimerized fatty acid and also
0.5 to 15 mol % of monomeric fatty acid having 12 to 22 carbon atoms and
20 to 55 mol % of an amine having 2 to 40 carbon atoms which bears 2 or more primary amino groups,
   wherein the dimerized fatty acids may be up to 65% replaced by aliphatic dicarboxylic acids having 4 to 12 carbon atoms.

With regard to the amine components in the polyamides, polyether polyols having primary amino end groups are preferably suitable, as already observed above. Polyether polyols having amino end groups that are only minimally water-soluble, if at all, are preferred. Molecular weights of the amino-terminated polyether polyols used are more particularly between 700 and 2500 g/mol. The bis(3-aminopropyl)polytetrahydrofurans are a particularly suitable class of raw materials for example.

It is further possible to use, in particular, primary alkylenediamines having 2 to 10 carbon atoms, selected from the amines recited above.

A further suitable class of diamines is derived from the dimeric fatty acids and contains primary amino groups instead of the carboxyl groups. Substances of this kind are frequently called dimer diamines. They are obtained by nitrile formation from the dimerized fatty acids and subsequent hydrogenation.

The aliphatic dicarboxylic acids recited above can be used as carboxylic acids. Suitable aliphatic carboxylic acids preferably have from 4 to 12 carbon atoms. These acids may replace up to 65%, in terms of moles, of dimeric fatty acid. It is further possible to use long-chain amino carboxylic acids such as 11-aminoundecanoic acid or else laurolactam.

A person skilled in the art will know that adding sebacic acid can raise the melting point of polyamides within certain limits. Similarly, the polyamide raw materials known in fibre chemistry, such as caprolactam for example, can also be used in small amounts. These materials make it possible for a person skilled in the art to raise the melting point within certain limits.

When selecting the monofunctional, difunctional or trifunctional raw materials to be used it must be ensured that meltable, i.e. noncrosslinked, products are obtained. For example, when crosslinking/gelling occurs, the proportion of trifunctional components (trimeric fatty acids) can be lowered and/or the level of monofunctional amines or fatty acids raised to obtain polymers that have no tendency to gel.

In general, the amounts of the amine and of the carboxylic acids are chosen so as to obtain polyamides that include carboxylic groups at 1-120 meq/kg of solids, more particularly between 10 to 100 meq/kg. Alternatively, it is also possible to use an excess of amines, in which case an amine content between 1-140 meq/kg of solids is to be obtained, more particularly between 10 to 100 meq/kg. The molecular weight (measured as number average molecular weight as obtainable via GPC) can be between 30 000 to 300 000 g/mol, more particularly between 50 000 up to 150 000 g/mol. The viscosity of the polyamides shall be between 5000 up to 100 000 mPas (measured at 200° C.), more particularly up to 50 000 mPas.

The hot-melt adhesives suitable for the purposes of the present invention, in addition to the carbodiimide and the antioxidant, may contain further customary additives. Examples thereof are tackifying resins, for example adipinic acid, adipinic esters, terpene resins, terpene phenolic resins or hydrocarbon resins; fillers, for example silicates, talc, calcium carbonates, clays, carbon black or pigments; stabilizers, for example of the type of the sterically hindered phenols or of the aromatic amine derivatives; fibrous additives, such as natural fibres, polymeric fibres or glass fibres. In general, these additives should not be included in a hot-melt adhesive of the present invention in a total of more than 15% by weight.

### (3) Carbodiimide

The carbodiimide compound preferably to be used according to the present invention is initially not subject to any special requirement in respect of its chemical structure as long as the carbodiimide is capable of stabilizing the colour of hot-melt adhesives within the meaning of the present invention.

Useful carbodiimide compounds for the purposes of the present invention include those synthesized by commonly known methods. The compound is obtainable for example by conducting a decarboxylation-condensation reaction of various polyisocyanates using an organophosphorus compound or an organometal compound as carbodiimidation catalyst at a temperature of not less than about 70° C. without use of any solvent or use of an inert solvent.

Examples of a monocarbodiimide compound included in the carbodiimide compounds described above are dicyclohexylcarbodiimide, diisopropylcarbodiimide, dimethylcarbodiimide, diisobutylcarbodiimide, dioctylcarbodiimide, tert-butylisopropylcarbodiimide, 2,6-diisopropylphenylenecarbodiimide diphenylcarbodiimide, di-tert-butylcarbodiimide and di-β-naphthylcarbodiimide, of which dicyclohexylcarbodiimide or diisopropylcarbodiimide is particularly preferable with regard to industrial applicability.

Corresponding processes for preparing carbodiimides and correspondingly suitable compounds are described for example in U.S. Pat. No. 2,941,956 J. Org. Chem. 28, 2069-2075 (1963) and Chemical Review, 1981, Vol. 81, No. 4, pages 619 to 621.

An organic diisocyanate as a starting material for preparing a polycarbodiimide compound comprises for example aromatic diisocyanate, aliphatic diisocyanate, alicyclic diisocyanate or a mixture thereof, and comprises specifically 1,5-naphthalene diisocyanate, 4,4′-diphenylmethane diisocyanate, 4,4′-diphenyldimethylmethane diisocyanate, 1,3-phenylene diisocyanate, 1,4-phenylene diisocyanate, 2,4-tolylene diisocyanate, 2,6-tolylene diisocyanate, a mixture of 2,4-tolylene diisocyanate and 2,6-tolylene diisocyanate, hexamethylene diisocyanate, cyclohexane 1,4-diisocyanate, xylylene diisocyanate, isophorone diisocyanate, dicyclohexylmethane 4,4′-diisocyanate, methylcyclohexane diisocyanate, tetramethylxylylene diisocyanate, 2,6-diisopropylphenylene isocyanate and 1,3,5-triisopropylbenzene 2,4-diisocyanate.

In addition, in the case of the above-described polycarbodiimide compound, the degree of polymerization can be adequately controlled by using a compound, such as monoisocyanate, capable of reacting with a terminal isocyanate group of the polycarbodiimide compound.

The monoisocyanate for controlling the degree of polymerization by protecting a terminal group of the polycarbodiimide compound comprises phenyl isocyanate, tolyl isocyanate, dimethylphenyl isocyanate, cyclohexyl isocyanate, butyl isocyanate and naphthyl isocyanate.

In addition, the end-capping agent for controlling the degree of polymerization by protecting a terminal group of the polycarbodiimide compound is not limited to the above-described monoisocyanates, but also includes active hydrogen compounds reactive with isocyanate, for example (i) an aliphatic, aromatic or alicyclic compound having an —OH group, such as methanol, ethanol, phenol, cyclohexanol, N-methylethanolamine, oligo- or polyethylene glycol monomethyl ether and oligo- or polypropylene glycol monoalkyl ethers, fatty and oleyl alcohols; (ii) a compound having an ═NH group, such as diethylamine and dicyclohexylamine; (iii) a compound having an ═NH₂ group, such as butylamine and cyclohexylamine; (iv) a compound having a —COOH group, such as succinic acid, benzoic acid and cyclohexanecarboxylic acid; (v) a compound having an —SH group, such as ethyl mercaptan, allyl mercaptan and thiophenol; and (vi) a compound having an epoxy group.

The decarboxylation-condensation reaction of the above-described organic diisocyanate is carried out in the presence of a suitable carbodiimidation catalyst. Preferable carbodiimidation catalysts to be used are an organophosphorus compound and an organometal compound [a compound represented by the general formula M-(OR)₄, where M is titanium (Ti), sodium (Na), potassium (K), vanadium (V), tungsten (W), hafnium (Hf), zirconium (Zr), lead (Pb), manganese (Mn), nickel (Ni), calcium (Ca) and barium (Ba) and the like; R is an alkyl group or aryl group having 1 to 20 carbon atoms]; and among the organophosphorus compounds it is phospholene oxide and among the organometal compounds it is alkoxides of titanium, hafnium and zirconium which are particularly preferable from the viewpoint of activity. Further to be mentioned are strong bases, for example alkali or alkaline earth metal hydroxides or oxides, alkoxides and phenoxides.

The above-described phospholene oxides include specifically 3-methyl-1-phenyl-2-phospholene 1-oxide, 3-methyl-1-ethyl-2-phospholene 1-oxide, 1,3-dimethyl-2-phospholene 1-oxide, 1-phenyl-2-phospholene 1-oxide, 1-ethyl-2-phospholene 1-oxide, 1-methyl-2-phospholene 1-oxide and double bond isomers thereof. Of these, 3-methyl-1-phenyl-2-phospholene 1-oxide is particularly preferable owing to its easy industrial availability.

The carbodiimide compound is more particularly 4,4′-dicyclohexyl-methanecarbodiimide (degree of polymerization=2 to 20), tetramethylxylylenecarbodiimide (degree of polymerization=2 to 20), N,N-dimethylphenylcarbodiimide (degree of polymerization=2 to 20) and N,N′-di-2,6-diisopropylphenylenecarbodiimide (degree of polymerization=2 to 20) and the like, and is not specifically limited as long as the compound has at least one carbodiimide group in a molecule having such function.

Carbodiimides suitable for the purposes of the present invention are, more particularly, monomeric, dimeric or polymeric carbodiimides.

A plurality of preferred embodiments of the carbodiimide compound will now be more particularly described.

Carbodiimides for the purposes of the invention are preferably compounds of the general formula

R′-(—N═C═N—R—)ₙ-R″ (I)

where
R is an aromatic, aliphatic, cycloaliphatic or araliphatic radical which in the case of an aromatic or araliphatic radical may bear in an ortho position, preferably in both ortho positions relative to the aromatic carbon atom bearing the carbodiimide group, aliphatic and/or cycloaliphatic substituents having 2 or more carbon atoms, preferably branched or cyclic aliphatic radicals having 3 or more carbon atoms, more particularly isopropyl groups,
R′ is aryl, aralkyl or R—NCO, R—NHCONHR¹, R—NHCONR¹R² and R—NHCOOR³,
R″ is —N═C═N-aryl, —N═C═N-alkyl, —N═C═N-cycloaliphatic, —N═C═N-aralkyl, —NCO, —NHCONHR¹, —NHCONR¹R² or NHCOOR³,
wherein, in R′ and R″, R¹ and R² are independently identical or different and each represent an alkyl, cycloalkyl or aralkyl radical, and R³ has one of the meanings of R¹ or is a polyester or polyamide radical, and
n is an integer from 1 to 5000, preferably from 1 to 500.

A first embodiment of the present invention utilizes a monocarbodiimide (monomeric). The compounds concerned preferably have the formula I where n=1, and R¹ to R⁴ are each as defined above. It is particularly preferable for the monocarbodiimide to have

the following general formula (II):

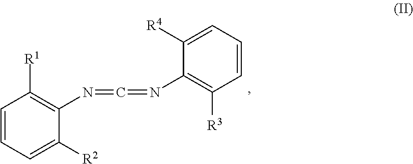

where R¹ to R⁴ are each independently a straight-chain or branched C₂-C₂₀ alkyl radical, a C₂-C₂₀ cycloalkyl radical, a C₆-C₁₅ aryl radical or a C₆-C₁₅ aralkyl radical.

The radicals R¹ to R⁴ are preferably C₂-C₂₀ alkyl and/or C₂-C₂₀ cycloalkyl radicals.

The radicals R¹ to R⁴ are more preferably C₂-C₂₀ alkyl radicals.

By C₂-C₂₀ alkyl and/or C₂-C₂₀ cycloalkyl radicals herein are meant more particularly ethyl, propyl, isopropyl, sec-butyl, tert-butyl, cyclohexyl and dodecyl radicals, of which the isopropyl radical is particularly preferred.

By C₆-C₁₅ aryl and/or C₆-C₁₅ aralkyl radicals herein are meant more particularly phenyl, tolyl, benzyl and naphthyl radicals.

An appropriate carbodiimide is commercially available from Rhein Chemie Rheinau GmbH under the designation Additin® 8500, Stabaxol® I or Stabaxol® I LF. Similarly, the products marketed by Rasching under the designation Stabilisator 3000, 7000 and 7000 A can also be used for the purposes of the present invention.

A second embodiment of the present invention utilizes a polymeric carbodiimide.

An appropriate polymeric carbodiimide has the general formula (I)

R′-(—N═C═N—R—)ₙ-R″ (I)

where
R is an aromatic, aliphatic, cycloaliphatic or araliphatic radical which in the case of an aromatic or araliphatic radical may bear in an ortho position, preferably in both ortho positions relative to the aromatic carbon atom bearing the carbodiimide group, aliphatic and/or cycloaliphatic substituents having 2 or more carbon atoms, preferably branched or cyclic aliphatic radicals having 3 or more carbon atoms, more particularly isopropyl groups,
R′ is aryl, aralkyl or R—NCO, R—NHCONHR¹, R—NHCONR¹R² and R—NHCOOR³,
R″ is —N═C═N-aryl, —N═C═N-alkyl, —N═C═N-cycloaliphatic, —N═C═N-aralkyl, —NCO, —NHCONHR¹, —NHCONR¹R² or NHCOOR³,
wherein, in R′ and R″, R¹ and R² are independently identical or different and each represent an alkyl, cycloalkyl or aralkyl radical, and R³ has one of the meanings of R¹ or is a polyester or polyamide radical, and
n is an integer from 2 to 5000, preferably from 2 to 500.

In a first preferred form of these polymeric carbodiimides, R is an aromatic or araliphatic radical which in at least one ortho position, preferably in both ortho positions relative to the aromatic carbon atom bearing the carbodiimide group bears aliphatic and/or cycloaliphatic substituents having 2 or more carbon atoms, preferably branched or cyclic aliphatic radicals having 3 or more carbon atoms, more particularly isopropyl groups.

Of particular suitability are carbodiimides of the general formulae (I) and (II) that are isopropyl substituted in the ortho positions relative to the carbodiimide group and that are likewise isopropyl substituted in the para position relative to the carbodiimide group.

In a second preferred form of these polymeric carbodiimides, R is an aromatic radical which is bonded to the carbodiimide group (—N═C═N—) via a C₁-C₈ alkyl radical, preferably via a C₁-C₄ alkyl radical.

It is further also possible to use polymeric aliphatic carbodiimides, for example based on isophorone diisocyanate or H12-MDI (hydrogenated MDI) which are available from Nisshinbo®.

The carbodiimides and/or polycarbodiimides of the general formulae (I) and (II) respectively are obtainable using monoisocyanates and/or diisocyanates, which are reacted by decarboxylative condensation at elevated temperatures, for example at 40° C. to 200° C., in the presence of catalysts to form the corresponding carbodiimides. Suitable processes are described in DE-A-11 30 594 and FR 1 180 370. Strong bases or phosphorus compounds have proved useful as catalysts for example. Preference is given to using phospholene oxides, phospholidines or phospholine oxides and also the corresponding sulphides. It is further possible to use tertiary amines, basic metal compounds, carboxylic acid metal salts and nonbasic organometal compounds as catalysts.

The carbodiimides and/or polycarbodiimides used are obtainable using any isocyanate, although the present invention preferably utilizes carbodiimides and/or polycarbodiimides based on C₁-C₄-alkyl-substituted aromatic isocyanates such as, for example, 2,6-diisopropylphenyl isocyanate, 2,4,6-triisopropylphenyl 1,3-diisocyanate, 2,4,6-triethylphenyl 1,3-diisocyanate, 2,4,6-trimethylphenyl 1,3-diisocyanate, 2,4′-diisocyanatodiphenylmethane, 3,3′,5,5′-tetraisopropyl-4,4′-diisocyanatodiphenylmethane, 3,3′,5,5′-tetraethyl-4,4′-diisocyanatodiphenylmethane, tetramethylxylene diisocyanate or mixtures thereof, and on substituted aralkyls, such as 1,3-bis(1-methyl-1-isocyanatoethyl)benzene. It is particularly preferable for the carbodiimides and/or polycarbodiimides to be based on 2,4,6-triisopropylphenyl 1,3-diisocyanate. Polycarbodiimides may additionally contain, when prepared from isocyanates, still reactive NCO groups and complexed monomeric isocyanates.

These NCO-containing polycarbodiimides can be modified by using reactive, hydrogen-containing compounds such as alcohols, phenols or amines to eliminate the isocyanate groups present (cf. DE 11 56 401 A and DE 24 19 968 A). In this regard, attention must also be more particularly drawn to the use of polypropylene glycol monoalkyl ethers and of fatty and oleyl alcohol radicals for endcapping.

The polymeric carbodiimides of the general formula (II) may further be endcapped with isocyanate compounds.

Polymeric carbodiimides within the meaning of the present invention are commercially available from Rhein Chemie Rheinau GmbH under the designation of Stabaxol® P, Stabaxol® P100, Stabaxol® P200 or Stabaxol® P400. Similarly, the products marketed by Rasching under the designation Stabilisator 2000, 9000 and 11000 can also be used for the purposes of the present invention.

The carbodiimides can herein also be used as a mixture of two or more carbodiimides.

A further embodiment of the present invention thus utilizes a mixture of various carbodiimides. When a mixture of carbodiimides is used, the carbodiimides used may be selected from the group consisting of monomeric, dimeric or polymeric carbodiimides, in which case the above observations in respect of the compounds of the general formulae (I) and (II) are referenced in respect of the monomeric carbodiimides and the polymeric carbodiimides.

It is further preferable for the purposes of the present invention to use carbodiimides having a reduced content of free isocyanates. Preferred carbodiimides preferably contain less than 1% by weight of free isocyanates.

In general, the carbodiimide compounds are used in amounts of in each case between 0.001% by weight and 10% by weight, preferably 0.01% by weight and 5% by weight, more preferably 0.01% by weight and 1% by weight, even more preferably between 0.1% and 1% by weight and yet even more preferably between 0.2% and 0.8% by weight, all based on the hot-melt adhesive/hot-melt adhesive composition.

Antioxidant and carbodiimide compound can be used in any desired ratio relative to each other. Preference is given to using antioxidant to carbodiimide compound in a ratio ranging from 1:2 to 1:4.

The carbodiimides to be used in accordance with the present invention for colour-stabilizing hot-melt adhesives are mixed with the hot-melt adhesives, before or after, preferably after production thereof, isolated or together with the antioxidant. This process likewise forms part of the subject matter of the present invention. For example, the carbodiimides and/or polycarbodiimides to be used according to the present invention can be mixed directly with the hot-melt adhesives together with the antioxidant to form a blend. The mixing can be carried out on mixing assemblies typical of plastics processing (DIN 24450, Saechtling-Kunststofftaschenbuch). Particularly useful mixing assemblies include kneaders, single-screw extruders, twin-screw extruders, cascade extruders, devolatilization extruders, multi-screw extruders and planetary roll extruders, reactor and tank apparatuses. The operation is typically carried out at above the melting temperature of at least one of the components.

The hot-melt adhesives of the present invention may further be produced by incorporating further known additives such as, for example, stabilizers, fillers, dyes, flame retardants and lubricants.

In accordance with the present invention, the hot-melt adhesive can be used for example in the packaging industry, more particularly for adhering cartons, envelopes and bags; apparel, more particularly for fusing shoulder pads into jackets, oil filters, more particularly in vehicles for gluing paper rolls into the casing; electrical engineering, more particularly in encapsulating structural components and electronics as casing replacement; cable ducts and sealing sleeves, more particularly for lines in motor vehicles; the furniture and wood industry; laminating technology; the footwear industry; diapers, more particularly for adhering the absorbent webstock into the backsheet; the carpet industry; the home improvement sector, more particularly in the form of hot glue guns with glue sticks; and bookbinding, more particularly for attaching the cover to the book.

Embodiments of the present invention will now be more particularly described without, however, the invention being in any way restricted thereto.

### EXEMPLARY EMBODIMENTS

### Example 1

A hot-melt adhesive based on Dynacoll® 7360 was prepared and additized in accordance with the table which follows:

(1) 2% of Stabaxol® P200 as polymeric carbodiimide based on tetramethylxylene diisocyanate, endcapped with polyethylene glycol monomethyl ether
(2) 0.8% of Stabaxol® P200 and 0.24% of Irganox® 3052 (2-(1,1-dimethylethyl)-6-[[3-(1,1-dimethylethyl)-2-hydroxy-5-methylphenyl]methyl-4-methylphenyl]acrylate)
(3) 0.8% of Stabaxol® P200 and 0.24% of Irganox® 245 (ethylenebis(oxyethylene)bis(3-(5-tert-butyl-4-hydroxy-m-tolyl) propionate))
(4) 0.8% of Stabaxol® P200 and 0.24% of Irganox® 1010 (pentaerythritol tetrakis(3-3,5-di-tert-butyl-4-hydroxyphenyl)propionate)
(5) 0.8% of Stabaxol® P200 as polymeric carbodiimide based on tetramethylxylene diisocyanate, endcapped with polyethylene glycol monomethyl ether.
(6) without additives, standard reference

All amount recitations are in % by weight.

The hot-melt adhesive was prepared as follows:

Dynacoll®, commercially available from Evonik Degussa, is a linear copolyester having primary hydroxyl functions and a medium molecular weight.

First, the copolyester is evacuated for 30 minutes and at 120° C. Then, 11.67% by weight of diphenylmethane diisocyanate (MDI), based on the overall formulation, is added, followed by reaction at 120° C. for 60 minutes.

Then, the additives are incorporated in the hot-melt adhesive and an exposure time to the additives of 1 hour is ensured.

The hot-melt adhesives thus prepared and additized (hotmelts) were subjected to thermoageing at 130° C. for 48 hours in a cartridge. The hot-melt adhesive was filled into an aluminium cartridge (light and moisturetight) and aged at 130° C. in a circulating air oven for 48 hours.

Evaluation was as follows, CIELab measurement:

In the CIELab colour space (CIE*L*a*b), the L value signifies luminance or psychometric lightness (from black to white). The a values range from −100 (green) to +100 (red) and the b values range from −100 (blue) to +100 (yellow). The closer the a and b values are to zero, the more neutral the hue is. L=50 and a=0/b=0 corresponds to a median, absolutely neutral grey.

Number of determinations: 1

### Apparatus: LICO 200

11 mm round cuvette

### Measurement Procedure:

The hot-melt cartridge is dried in a drying cabinet at 130° C.

One hour prior to the desired thermoageing time the sample is taken. The sample is transferred from the cartridge into an 11 mm round cuvette. The sample is aged once more for a further hour under reduced pressure (to draw the gas bubbles out of the sample) at 130° C. in a vacuum drying cabinet. Once the complete desired thermoageing time has expired, the CIELab values are measured with the LICO 200 instrument (manufacturer: Dr. Lange, Berlin) as described hereinbelow:

The LICO 200 instrument is calibrated. The sample is filled into an 11 mm round cuvette, placed in the measuring aperture and the measurement is started.

### Evaluation:

After measurement, the colorimetric values are displayed in the configured colour system.

| Sample 1 | | |
|---|---|---|
| comparison | No ageing | after ageing |
| L lightness | 96.3 | 89.4 |
| b value | −2.8 | 2.9 |
| a value | 14.1 | 37.6 |

| Sample 2 | | |
|---|---|---|
| invention | No ageing | After ageing |
| L lightness | 96.3 | 94.7 |
| b value | −1.9 | −1.9 |
| a value | 14.2 | 24.6 |

| Sample 3 | | |
|---|---|---|
| comparison | No ageing | After ageing |
| L lightness | 100 | 98.7 |
| b value | 4.5 | 9.7 |
| a value | −0.9 | −2.1 |

| Sample 4 | | |
|---|---|---|
| comparison | No ageing | After ageing |
| L lightness | 99.6 | 99.8 |
| b value | 2.8 | 4.4 |
| a value | −0.5 | −1.2 |

| Sample 5 | | |
|---|---|---|
| comparison | No ageing | After ageing |
| L lightness | 95.8 | 92.9 |
| b value | −1.9 | −0.6 |
| a value | 13.8 | 28.4 |

| Sample 6 | | |
|---|---|---|
| Standard | | |
| reference | No ageing | After ageing |
| L lightness | 94.4 | 95.9 |
| b value | −1.5 | −2.1 |
| a value | 19.6 | 19.5 |

### Summary:

These tests show that the use of (2-(1,1-dimethylethyl)-6-[[3-(1,1-dimethylethyl)-2-hydroxy-5-methylphenyl]methyl-4-methylphenyl]acrylate) combined with carbodiimide provides effective colour stabilization. Other antioxidants, for example Irganox® 245 or Irganox® 1010 show distinctly worse results (a distinct dark colour) than the mixture of the present invention. Similarly, the carbodiimide alone is distinctly worse than the combination of the present invention.

What is claimed is:

1. Hot-melt adhesive composition, characterized in that the composition comprises at least 2-(1,1-dimethylethyl)-6-[[3-(1,1-dimethylethyl)-2-hydroxy-5-methylphenyl]methyl-4-methylphenyl]acrylate as antioxidant and at least one carbodiimide compound.

2. Hot-melt adhesive composition according to claim 1, characterized in that the at least one antioxidant is used in amounts of between 0.001% by weight and 10% by weight, based on the hot-melt adhesive.

3. Hot-melt adhesive composition according to claim 1 or 2, characterized in that the at least one carbodiimide compound is used in amounts of between 0.001% by weight and 10% by weight, based on the hot-melt adhesive.

4. Hot-melt adhesive composition according to any one of claims 1 to 3, characterized in that the hot-melt adhesive comprises a hot-melt adhesive composition based on polyurethane, polyamide, copolyamide, polyolefin, ethylene-vinyl acetate copolymer, polyester, polyacrylate and vinylpyrrolidone-vinyl acetate copolymer.

5. Hot-melt adhesive composition according to any one of claims 1 to 4, characterized in that it additionally contains antioxidants selected from the group consisting of sterically hindered phenol, tocopherol, bisbenzotriazole, phosphite, thiophenylbisbenzoxazole derivatives and/or benzophenone.

6. Hot-melt adhesive composition according to any one of claims 1 to 4, characterized in that the carbodiimide compound is a compound of formula (I)
R′-(—N═C═N—R—)ₙ-R″ (I)
where
R is an aromatic, aliphatic, cycloaliphatic or araliphatic radical which in the case of an aromatic or araliphatic radical may bear in an ortho position, preferably in both ortho positions relative to the aromatic carbon atom bearing the carbodiimide group, aliphatic and/or cycloaliphatic substituents having 2 or more carbon atoms, preferably branched or cyclic aliphatic radicals having 3 or more carbon atoms, more particularly isopropyl groups,
R′ is aryl, aralkyl or R—NCO, R—NHCONHR¹, R—NHCONR¹R² and R—NHCOOR³,
R″ is —N═C═N-aryl, —N═C═N-alkyl, —N═C═N-cycloaliphatic, —N═C═N-aralkyl, —NCO, —NHCONHR¹, —NHCONR¹R² or NHCOOR³,
wherein, in R′ and R″, R¹ and R² are independently identical or different and each represent an alkyl, cycloalkyl or aralkyl radical, and R³ has one of the meanings of R¹ or is a polyester or polyamide radical, and
n is an integer from 1 to 5000.

7. Process to stabilize the colour of hot-melt adhesives in the melt by using 2-(1,1-dimethylethyl)-6-[[3-(1,1-dimethylethyl)-2-hydroxy-5-methylphenyl]methyl-4-methylphenyl]acrylate.

8. Process according to claim 7, characterized in that there is additionally used at least one compound of the formula (I)
R′-(—N═C═N—R—)ₙ-R″ (I)
where
R is an aromatic, aliphatic, cycloaliphatic or araliphatic radical which in the case of an aromatic or araliphatic radical may bear in an ortho position, preferably in both ortho positions relative to the aromatic carbon atom bearing the carbodiimide group, aliphatic and/or cycloaliphatic substituents having 2 or more carbon atoms, preferably branched or cyclic aliphatic radicals having 3 or more carbon atoms, more particularly isopropyl groups,
R′ is aryl, aralkyl or R—NCO, R—NHCONHR¹, R—NHCONR¹R² and R—NHCOOR³,
R″ is —N═C═N-aryl, —N═C═N-alkyl, —N═C═N-cycloaliphatic, —N═C═N-aralkyl, —NCO, —NHCONHR¹, —NHCONR¹R² or NHCOOR³,
wherein, in R′ and R″, R¹ and R² are independently identical or different and each represent an alkyl, cycloalkyl or aralkyl radical, and R³ has one of the meanings of R¹ or is a polyester or polyamide radical, and
n is an integer from 1 to 5000.

9. Process according to either of claims 7 and 8, characterized in that the at least one carbodiimide compound is used in amounts of between 0.001% by weight and 10% by weight, based on the hot-melt adhesive.

10. Use of hot-melt adhesive composition according to any one of claims 1 to 6 in packaging, apparel, oil filters, electrical engineering, cable ducts and sealing sleeves, the furniture and wood industry, laminating technology, the footwear industry, diapers, the carpet industry, the home-improvement sector and bookbinding.

11. Use of hot-melt adhesive composition according to any one of claims 1 to 6 for adhering cartons, envelopes and bags, for fusing shoulder pads into jackets, for gluing paper rolls into the casing, in the encapsulation of structural components and electronics as casing replacement, for lines in motor vehicles, for adhering the absorbent webstock into the backsheet, in the form of hot glue guns with glue sticks, and for attaching the cover to the book.

12. Process for producing a hot-melt adhesive composition, characterized in that following production of the hot-melt adhesive at least one carbodiimide is mixed together with 2-(1,1-dimethylethyl)-6-[[3-(1,1-dimethylethyl)-2-hydroxy-5-methylphenyl]methyl-4-methylphenyl]acrylate as antioxidant for colour stabilization of the hot-melt adhesive.

13. Process according to claim 12 for producing a hot-melt adhesive according to any one of claims 1 to 6.

14. Hot-melt adhesive composition obtainable by a process according to claim 12 or 13.

15. Use of 2-(1,1-dimethylethyl)-6-[[3-(1,1-dimethylethyl)-2-hydroxy-5-methylphenyl]methyl-4-methylphenyl]acrylate for colour stabilization of hot-melt adhesives in the melt.
